(19) United States
(12) Patent Application Publication
(10) Pub. No.: US 2023/0332536 A1
(43) Pub. Date: Oct. 19, 2023

(54) Instrument and Process Air Alternative Source

(71) Applicants: Charles Edmond Pruitt, III, Atlanta, TX (US); Pamela Jane Pruitt, Atlanta, TX (US)

(72) Inventors: Charles Edmond Pruitt, III, Atlanta, TX (US); Pamela Jane Pruitt, Atlanta, TX (US)

(21) Appl. No.: 18/129,896

(22) Filed: Apr. 2, 2023

Related U.S. Application Data
(60) Provisional application No. 63/332,273, filed on Apr. 19, 2022.

(51) Int. Cl. F02B 63/00; F02B 67/06; B60T 17/02

(52) U.S. Cl. CPC F02B 63/00; F02B 67/06; B60T 17/02

(57) ABSTRACT

A method of mitigating greenhouse gases by producing compressed air supply for pneumatic instrument air powered measurement and control systems in place of process methane fuel gas. Exploiting ancillary industrial engines when present, by adding an air compressor designed for commercial truck and equipment air brake systems, that is affixed to and energized by said industrial engine, as an accessory to said engine wherein the primary product and function of the engine is to supply power for larger system processes and the production of pneumatic air is a secondary product. Eliminating the necessity of adding standalone air compressors for instrument air supply when applicable and the accumulative carbon foot print associated with the standalone air compressor through energy generation and or carbon emissions.

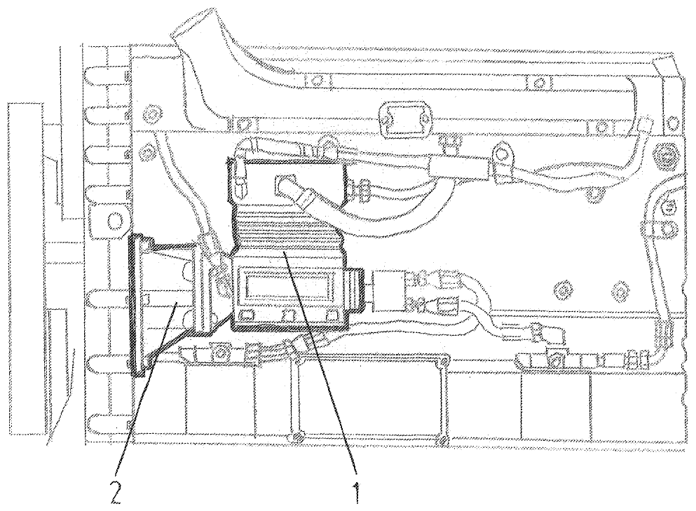

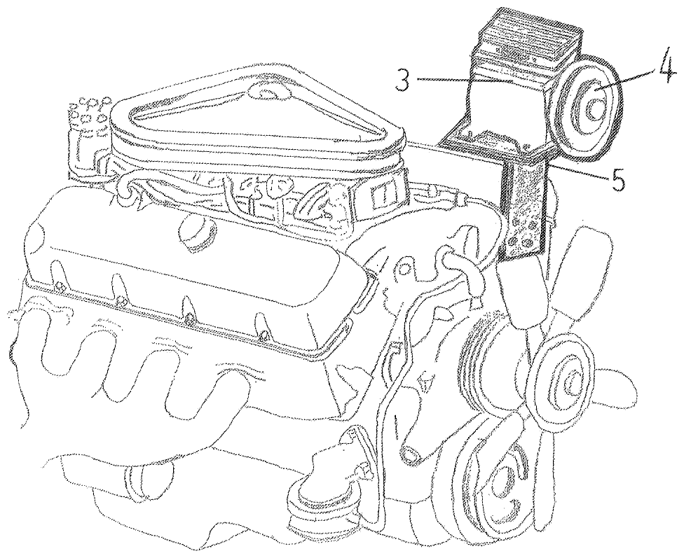

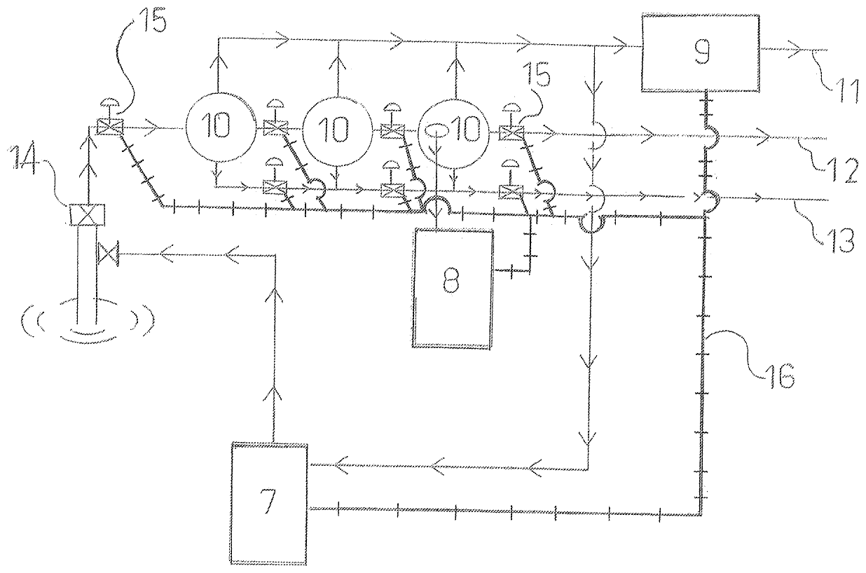

### CROSS-REFERENCE TO RELATED APPLICATIONS

Provisional Application

Date: Apr. 19, 2022

Application #: 63/332,273

Charles Edmond Pruitt III, Atlanta, TX

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable.

### STATEMENT REGARDING PRIOR DISCLOSURE BY THE INVENTOR OR A JOINT INVENTOR

Not Applicable.

### BACKGROUND OF THE INVENTION

(1) General field of implementation; Greenhouse gas (GHG) mitigation by converting pneumatic industrial control systems that have historically used natural methane gas (fuel gas), too compressed instrument air for the pneumatic function of instrument and control devices, particularly in the oil and gas industry sector. Eliminating the issue of control devices venting methane gas to the atmosphere when functioned, meeting Environmental and Social Governance mandates and eliminating a potential safety hazard from the system.

(2) Utilize existing technology in a novel application by incorporating engine driven air compressors that were designed, intended and utilized for commercial truck and equipment air brake systems on ancillary stationary industrial engines when present, to produce compressed service air for the pneumatic control systems. Thus, removing the dependence on methane gas to operate pneumatic control systems and utilizing the power of ancillary industrial engines that are necessary to perform other functions associated with the primary system for gas compression, gas lift, gas injection, liquid transfer, vapor recovery or electric generation.

### SUMMARY OF INVENTION

A change of process or method to mitigate greenhouse gases (GHG) and produce instrument air for oil and gas pneumatic measurement and control systems as an alternative too, adding standalone dedicated air compressors which require the addition of engines, motors, electricity and or increase exhaust emissions of the primary system, particularly when grid electricity is not available. Exploiting ancillary industrial engines that are not part of a motor vehicle and commonly necessary power units to hydrocarbon production and facilitation systems. By retrofitting an engine driven air compressor that was designed, intended and successfully utilized for air brake service on commercial trucks and equipment, too said industrial engines that are already a part of the overall process system to produce instrument air as a secondary product of the engine. Industrial engines are not produced with such air compressors, many industrial engines were derived from and share core components with commercial truck engines, therefore these engines will support and accept the addition of gear driven or belt driven brake system air compressors and when combined with an accumulation tank will produce sufficient pneumatic pressure and volume to function pneumatic measurement and control devices without adding expensive separate independent air compression, electric generation and exhaust emissions to the production or facilitation system.
Please See: U.S Environmental Protection Agency; Lessons Learned from Natural Gas STAR Partners “Convert Gas Pneumatic Controls to Instrument Air”. E.P.A. Review; “Oil and Gas Sector Pneumatic Devices”, pages 44-47.

### DESCRIPTION OF DRAWINGS

### Drawing 1/3

Is a depiction of an inline six cylinder internal combustion engine equipped with timing gear drive accessory port.

Lines:
1. Air compressor designed and used for braking system service air supply.
2. Accessory gear drive that is designed and manufactured for use with specific engines and accessories.

### Drawing 2/3

Is a depiction of a “V” configured internal combustion engine utilizing the belt drive system to energize the various accessories.

Lines:
3. Air compressor designed and used for braking system service air supply.
4. Belt drive pulley that is compatible with the engine accessory belt drive system and the compressor.
5. Bracket designed, manufactured or fabricated to affix the compressor to the engine in proper position and alignment with the engine and the belt drive.

### Drawing 3/3

Is a simplified depiction of an oil and gas production facility with pneumatic controls and valves and depictions of typical ancillary power units which could be used produce compressed instrument air for the pneumatic system.

Lines:
7. Ancillary gas lift compression unit or electric generator with industrial engine.
8. Ancillary vapor recovery compression unit with industrial engine.
9. Ancillary sales gas compression unit with industrial engine.
10. Oil and gas separation vessel.
11. Natural gas pipeline.
12. Oil pipeline.
13. Produced waste water pipeline.
14. Oil and gas wellhead.
15. Pneumatic controlled valve or actuator.
16. Pneumatic instrument air piping system.

### DETAILED DESCRIPTION OF INVENTION

The overriding goal to reduce carbon emissions from the production of oil and gas has mandated industry to mitigate greenhouse gases (GHG) by converting pneumatic measurement and control systems from operating on process methane fuel gas too compressed instrument air. Industry has focused on installing standalone air compressors for this purpose. In many cases, when grid electricity is not available requiring diesel electric generation to supply electric power to the standalone air compressor, thus increasing the expense, complexity and the carbon emissions of the process. Meanwhile not observing in many situations, the ancillary industrial engines commonly on location which play a necessary role in the oil and gas production and facilitation process. This problem has been studied for many years and experts in the field have noted in published writings that a problem existed with powering standalone air compressors in some locations. Specifically, the U.S. Environmental Protection Agency published Lessons Learned from Natural Gas STAR Partners entitled “Convert Gas Pneumatic Controls to Instrument Air” and the EPA Review; “Oil & Gas Sector Pneumatic Devices” pages 44-46. In this and other publications and as practiced in the field, no one has observed, incorporated or recognized the ability to utilize ancillary industrial engines that in some cases are present and necessary to the production facilitation process. This application for a utility patent, prescribes a change in method and or process that exploits and incorporates the surplus mechanical horsepower of ancillary stationary industrial engines when present, by combining air compressors to those industrial engines. The components are not new technology however the combination of an industrial engine with a air brake compressor is, and has proven to be novel and not obvious to experts and technicians in the industry as demonstrated in the aforementioned published writings and in the absence of implementation in the industry. Someone relatively skilled in the field will be able to comprehend, assemble the necessary parts and implement this method of producing instrument air. These ancillary engines performing other primary services, can be utilized to power air compressors that were designed and utilized to produce compressed air, when coupled with a regulator, volume accumulation tank and air driers will provide ample volume and pressure to sustain a pneumatic control and measurement system on compressed instrument air. Most industrial engines used in oil and gas production are derived from and share the same foundational designs as commercial truck (Drawing 1/3) and tractor (Drawing 2/3) engines which are commonly equipped with air compressors that supply compressed service air for air brake systems in tractor trailers and some heavy equipment applications, while industrial engines are produced for a single purpose and are not configured with accessory purposes. Therefore, the industrial engines can be easily adapted and manipulated with specific off the shelf parts to accept the appropriate drive systems either gear (Line 2) or belt drive (Line 4) and mounting configurations (Line 5) whether manufactured or fabricated that will successfully affix and energize the appropriately sized and configured air compressor (Lines 1&3) for the application. Air brake compressors are accessories to the engine, are designed to have the same life expectancy of the engine, they share the same coolant liquids and lubricating oils. When the engine is routinely maintained, so is the compressor. The most expeditious implementation and best use would involve identifying the engine manufacture and model that it was derived from, which applications the core components have been used in combination with an air brake compressor, then identifying the parts and part numbers that were used for that configuration and procuring the parts needed to facilitate the installation and operation of the appropriate compressor. This method when applicable, eliminates the need for the addition of standalone air compressors and the added expense of implementing and operating a standalone compressor as measured in cost, complexity and carbon footprint.

Hydrocarbons produced from the wellhead (Line 14) typically flow into a series of vessels (Item 10) for the purpose of product separation and storage. This process is largely automated by incorporating pneumatic controls (Line 15) which control levels and pressures in the various vessels and tanks. Said pneumatic controls are energized from a common piping system (Line 16) which can be supplied with compressed air from any variation of ancillary engines which maybe on site and a necessary part of the production process. Gas lift compression (Item 7) forces high pressure natural gas into the well bore as part of an artificial lift system to produce hydrocarbon liquids or may be an electric generator to power pump jacks. Vapor recovery systems (Item 8) capture fugitive gases from lower pressure systems and force them into the higher pressure systems. Sales gas compression (Item 9) pulls natural gas from the overall system and compresses the gas into pressures high enough to make entry into high pressure natural gas sales lines (Line 11). Pneumatic controls also affect the function and flow of oil discharge pipelines (Line 12) and produced water pipelines (Line 13) flowing to storage or disposal.

1. The invention claims a method of mitigating greenhouse gases (GHG), by substituting methane fuel gas in pneumatic systems with pneumatic air supply which comprises: an air compressor designed for commercial truck and equipment air brake service affixed too and energized by an ancillary stationary industrial engine, as an accessory to said engine wherein the primary product of said engine is not pneumatic air supply and production of pneumatic air supply is a secondary product.

2. A method of producing pneumatic air supply as in claim 1, wherein said air compressor is affixed to said engine utilizing an existing accessory port in components of said engine and said compressor is energized by the gear drive inside said engine.

3. A method of producing pneumatic air supply as in claim 1, wherein said air compressor is affixed to said engine utilizing a bracket for said engine and said compressor, said compressor is energized by a flexible belt drive system on said engine.

4. A method of producing pneumatic air supply as in claim 1, wherein said stationary engine is affixed to a permanent structure.

5. A method of producing pneumatic air supply as in claim 1, wherein said stationary engine is affixed to a portable skid apparatus.

6. A method of producing pneumatic air supply as in claim 1, wherein said stationary engine is affixed to a portable trailer apparatus.
